(19) United States
(12) Patent Application Publication
(10) Pub. No.: US 2002/0116209 A1
(43) Pub. Date: Aug. 22, 2002

(54) In-store product information retrieval system and method

(75) Inventor: Kazuo Tsuge, Tokyo (JP)

Correspondence Address: Steven I. Weisburd, DICKSTEIN SHAPIRO MORIN & OSHINSKY LLP, 41st Floor, 1177 Avenue of the Americas, New York, NY, 10036-2714, US

(73) Assignee: NEC Corporation

(21) Appl. No.: 10/026,988

(22) Filed: Dec. 20, 2001

(30) Foreign Application Priority Data
Dec. 22, 2000 (JP) 2000-390810

(51) Int. Cl. G06F 17/60

(52) U.S. Cl. 705/1

(57) ABSTRACT

In an in-store product information retrieval system, a means for making a request for retrieval of product information from the portable user terminal when the portable user terminal approaches to within a prescribed distance of a wireless apparatus corresponding to a product for which retrieval of product information is desired; a means for sending from the wireless apparatus to the store computer the request received from the portable user terminal by adding an identification number of the wireless apparatus; a database provided in the store computer and storing product information; a retrieval means, provided in the store computer, for performing retrieval of product information stored in the database based on the identification number of the wireless apparatus received from the wireless apparatus; are provided.

### BACKGROUND OF THE INVENTION

1. Field of the Invention

The present invention relates to an in-store product information system and method, and more particularly to an in-store product information retrieval system and method wherein a customer obtains product information by using a wireless terminal while moving about within a store.

2. Related Art

In the past, when shopping at a store, a customer headed for the store and took a product in hand to verify it, either purchasing the product and either taking it home or having it delivered if he or she liked the product. In the case in which a customer wished to ask about a price while shopping, the customer generally asked a store employee, and there were cases in which, being unable to reply, time was required while the store employee checked on the price, and cases in which it was not even possible to find a store employee, or in which there was a store employee, but the employee was currently waiting on another customer, therefore impeding efficient shopping.

As an example of an approach to solving this problem, there is a product sales processing system as disclosed in the Japanese unexamined patent publication (KOKAI) No. 05-20548. In this product sales processing system, the customer carries a portable wireless terminal having a barcode reader and a ten-key pad around the store. If there is a product in which the customer is interested, the customer either reads the barcode attached to the product, or directly inputs the product code thereof, using the ten-key pad of the terminal. This product code is sent to a host computer via the wireless terminal, whereupon the corresponding host computer performs a file retrieval, so as to search for the product name and price information, and sends this information to the portable terminal via a wireless apparatus. Upon receiving the product name and price information, the portable terminal indicates this information on a liquid-crystal display, thereby enabling the customer to verify the price of the product. It is then possible for the displayed information to be sent to the host computer in the form of a purchase order.

In the above-described conventional technology disclosed in the above-noted Japanese unexamined patent publication (KOKAI) No. 05-20548, however, in the case in which the customer wishes to obtain the name or price of the product, each time there is a product of interest, it is necessary for the customer to input the product code of the product, using the barcode reader or the ten-key pad, thereby necessitating a troublesome operation by the customer.

Accordingly, it is an object of the present invention to provide an in-store product information retrieval system solving the above-noted problem inherent in the conventional technology.

### SUMMARY OF THE INVENTION

To achieve the above-noted objects, the present invention adopts the following described technical constitution.

Specifically, the first aspect of the present invention is an in-store product information retrieval system having a portable user terminal, a wireless apparatus provided for each product displayed within a store and communicating with the portable user terminal, a store computer provided in the store and a network connecting the wireless apparatus with the store computer comprising: a means for making a request for retrieval of product information from the portable user terminal when the portable user terminal approaches to within a prescribed distance of a wireless apparatus corresponding to a product for which retrieval of product information is desired; a means for sending from the wireless apparatus to the store computer the request received from the portable user terminal by adding an identification number of the wireless apparatus; a database provided in the store computer and storing product information; a retrieval means, provided in the store computer, for performing retrieval of product information stored in the database based on the identification number of the wireless apparatus received from the wireless apparatus; a sending means, provided in the store computer, for sending retrieval results to the wireless apparatus with the identification number; and a receiving means, provided in the portable user terminal, for receiving retrieval results from the wireless apparatus.

In the second aspect of the present invention, a plurality of the wireless apparatuses are provided in the store and the wireless apparatuses are disposed at regular intervals.

In the third aspect of the present invention, the database has an identification number of the wireless apparatus and product information corresponding to the identification number of the wireless apparatus.

The fourth aspect of the present invention is an in-store product information retrieval system comprising: a portable user terminal, a wireless apparatus provided for each product displayed within a store and communicating with the portable user terminal, a transmitter provided in the wireless apparatus, a memory, provided in the wireless apparatus, for storing store information of the store, a store computer provided in the store, and a network connecting the wireless apparatus with the store computer, the system further comprising: a means for making a request for retrieval of store information from the portable user terminal to the wireless apparatus; a transferring means, provided in the wireless apparatus, for transferring the request received from the portable user terminal to the store computer;

a retrieval means, provided in the store computer, for performing retrieval of a wireless apparatus that stores store information in a memory thereof, based on the request received from the portable user terminal; an instruction means, provided in the store computer, for instructing a wireless apparatus obtained by the retrieval to transmit store information stored in the wireless apparatus to the portable user terminal; a transmitting means for transmitting the store information stored in the wireless apparatus to the portable user terminal, based on the instruction of the store computer; and a receiving means, provided in the portable user terminal, for receiving the store information from the wireless apparatus.

In the fifth aspect of the present invention, the wireless apparatus communicates with the portable user terminal by a first output power of the transmitter, when receiving the request for retrieval from the portable user terminal, and the wireless apparatus communicates with the portable user terminal by a second output power that is different from the first output power, when transmitting the store information from the wireless apparatus to the portable user terminal.

In the sixth aspect of the present invention, the wireless apparatus communicates with the portable user terminal by a prescribed output power of the transmitter, when receiving the request for retrieval from the portable user terminal, and the wireless apparatus communicates with the portable user terminal by a power that is equal to the output power, when transmitting the store information from the wireless apparatus to the portable user terminal.

### BRIEF DESCRIPTION OF THE DRAWINGS

FIG. 1 is a drawing showing the system configuration of an embodiment of the present invention.

FIG. 2 is a flowchart showing the operation of an embodiment of the present invention at the time of a product purchase.

FIG. 3 is a drawing showing an example of a product information display screen in an embodiment of the present invention.

FIG. 4 is a drawing showing an example of a purchaser information input screen in an embodiment of the present invention.

FIG. 5 is a flowchart showing the operation of an embodiment of the present invention when a product location information display request is made.

FIG. 6 is a drawing showing a store layout screen indicating a product location in an embodiment of the present invention.

### DETAILED DESCRIPTION OF THE PREFERRED EMBODIMENTS

Embodiments of the present invention are described in detail below, with references made to relevant accompanying drawings.

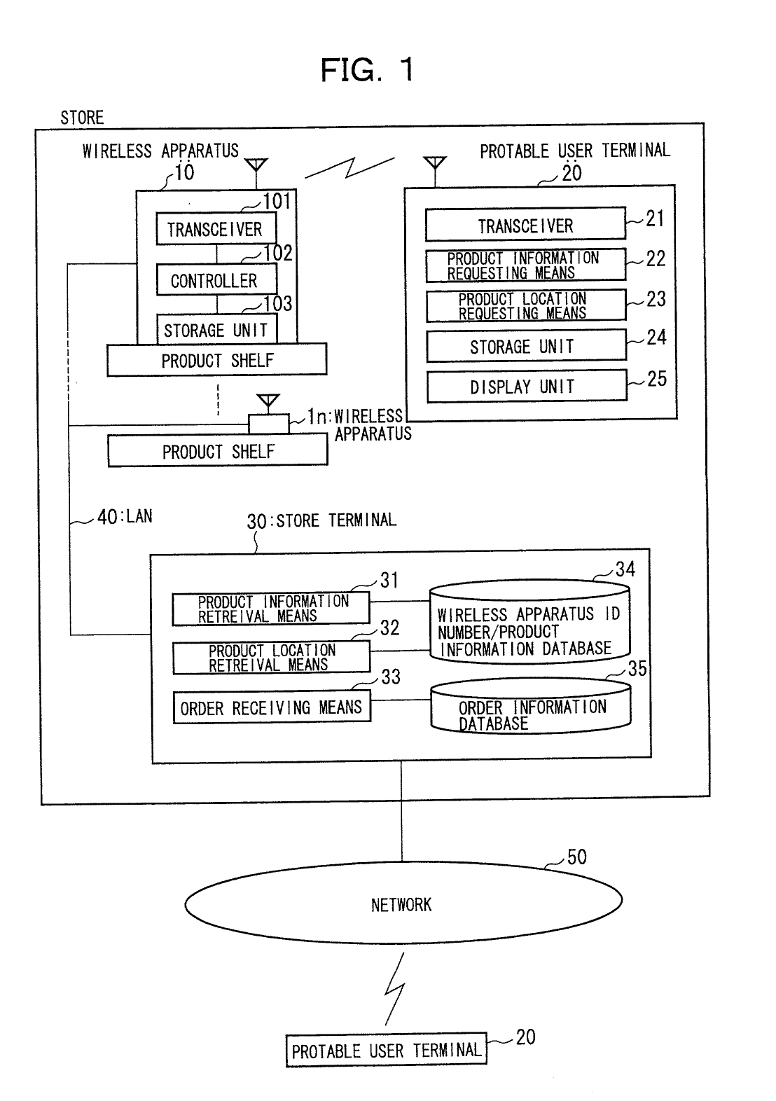

Specifically, FIG. 1 shows the configuration of an embodiment of the present invention, which has wireless apparatuses 10 to in, a portable user terminal 20, a store terminal 30, a LAN (local area network) 40 connecting the wireless apparatuses 10 to 1n and the store terminal 30, and a network 50 such as the Internet, to which the store terminal 30 is connected.

The wireless apparatuses 10 to 1n perform short-range wireless communication with the portable user terminal 20, conforming, for example, to the Bluetooth standard, and are provided on product display shelves through the store. Each wireless apparatus is provided in the display location of each product. The description of an embodiment of the present invention presented below is based on the case in which communication between the wireless apparatuses 10 to 1n and the portable user terminal 20 being performed in accordance with the Bluetooth standard. In accordance with the Bluetooth standard, short-range communication up to a distance of approximately 100 meters is possible, and it is possible by adjustment of the transmitting level to perform communication at any arbitrary distance within 100 meters.

The wireless apparatuses 10 to 1n have a transceiver 101, a controller 102, which controls transmission and reception of information between the portable user terminal 20 and the store terminal 30, and a storage unit 103. The storage unit 103 has priorly stored in it wireless apparatus identification numbers (ID), which serve as position information on the LAN for the purpose of discriminating the wireless apparatus 10 to 10n, and store layout information indicating the location in which the wireless apparatus is provided.

The portable user terminal 20 is an information processing device, such as a portable telephone or the like, which is provided with a Web browsing function and a wireless communication function conforming to the Bluetooth standard, this portable user terminal 20 having a wireless transceiver 21, a product information requesting means 22, a product location requesting means 23, a storage unit 24, and a display unit 25.

In the case in which a customer desires product information, such as a price of a product, the product information requesting means 22 sends a product information request signal to a wireless apparatus 10 to in provided corresponding to that product. The product location requesting means 23, in the case in which a customer desires to know to display location of a particular product, sends a product location request signal to the closest wireless apparatus 10 to 1n. The product information requesting means 22 and the product location requesting means 23 can be implemented at the portable user terminal 20 by providing corresponding hardware, such as switches or buttons or the like, and can alternatively be implemented by a button that is displayed on an application software screen as part of the portable user terminal 20.

The storage unit 24 stores product information received from the store terminal 30, and also has priorly stored within it purchaser information, such as a name and an address of a purchaser. The display unit 25 displays a product information received from the store terminal 30, or store layout information received from the wireless apparatus 10 to 1n, or product purchase screen, using, for example, a liquid-crystal display device.

The store terminal 30 is an information processing apparatus, such as a workstation or server or the like, installed in the store, this apparatus having a product information retrieval means 31, a product location retrieval means 32, a order receiving means 33, a wireless apparatus identification number/product information database 34, and an order information database 35.

In the case in which there is a request for product information from the portable user terminal 20, the product information retrieval means 31 searches the wireless apparatus identification number/product information database 34, based on a wireless apparatus identification number sent from the wireless apparatus 10 to 1n, and sends the corresponding product information to the portable user terminal 20 via the wireless apparatus 10 to 1n. In the case in which there was a product location request from the portable user terminal 20, the product information retrieval means 32 searches the wireless apparatus identification number/product information database 34, based on the product information sent from the portable user terminal 20, and issues an instruction to a wireless apparatus 10 to 1n having the corresponding wireless apparatus identification number to switch the transmitting level to the maximum and transmit store layout information indicating the location of the product. The order receiving means 33 adds to product information and purchaser information received from the portable user terminal 20 an order identification information, stores these information into the order information database 35, and sends the order identification information to the portable user terminal 20.

The wireless apparatus identification number/product information database 34 has priorly stored in it product information of products and the corresponding wireless apparatus identification numbers, which serve as location information for each of the wireless apparatuses 10 to 1n. The stored product information includes such information as product names, product numbers, prices, and achievable delivery dates. The order information database 35 has stored in it order identification information, corresponding product information and order purchaser information and the like. The stored order purchaser information includes such information as names, addresses of the purchaser, and specified delivery dates.

The LAN 40 is a network connecting the wireless apparatuses 10 to 1n and the store terminal 30, and can be a wireless LAN or a cable-connected LAN. The network 50 is a public communication network, such as the Internet, this being used, for example, to obtain product information by having the portable user terminal 20 access a website of the store terminal 30 via the network 50 from outside a store.

The operation of an embodiment of the present invention is below in further detail, with reference made to relevant drawings.

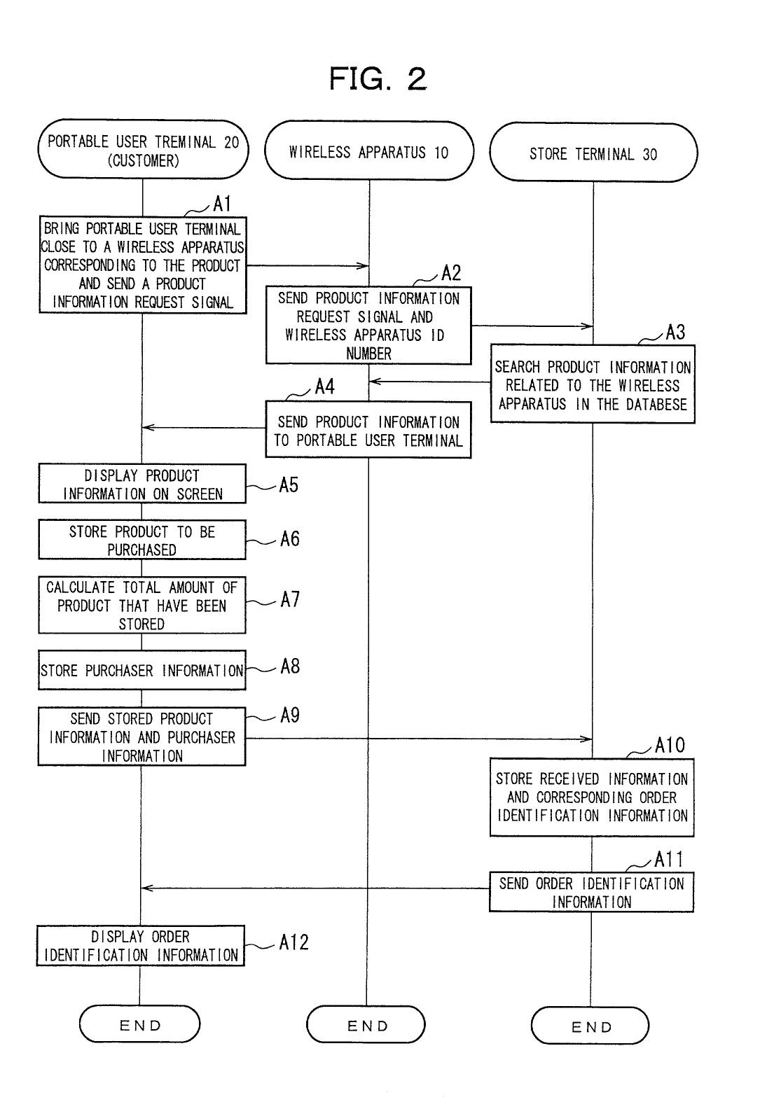

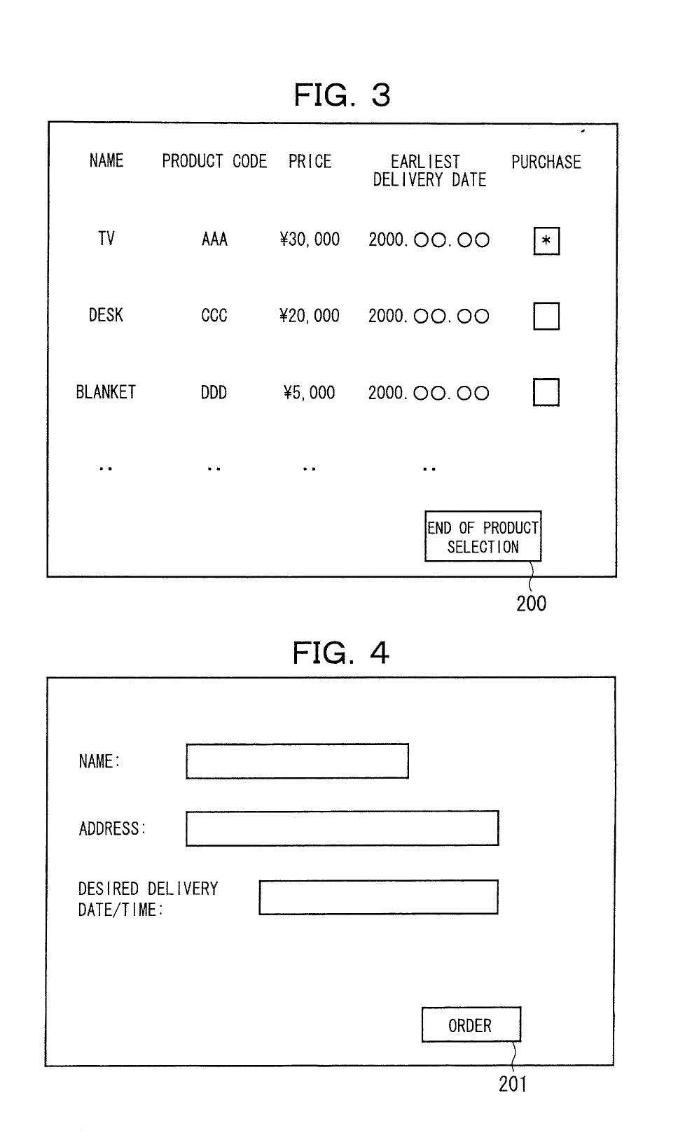

FIGS. 2 to FIG. 4 are drawings illustrating the case of purchasing a desired product in the store according to the present invention. FIG. 2 is a flowchart showing the operation of an embodiment of the present invention when a purchase is made of a product, FIG. 3 is a drawing showing an example of a product information display screen in an embodiment of the present invention, and FIG. 4 is a drawing showing an example of a purchaser information input screen in an embodiment of the present invention.

First, a customer brings a portable user terminal 20 close to a wireless apparatus 10 to 1n, which is provided for a product that the customer wishes to purchase, and presses a product information request switch on the portable user terminal 20, so as to send a product information request signal. For the purposes of the subsequent operational description, it will be assumed that the portable user terminal 20 has been brought into proximity of the wireless apparatus 10. The wireless apparatus 10 detects the product information request signal from the portable user terminal 20 via wireless communication system, which conforms to the Bluetooth standard (step A1 in FIG. 2).

In the store shown in FIG. 1, the seller displays the products at regular intervals. The wireless apparatuses are also installed at substantially the same interval as the product interval, in the same locations as the products. If a customer finds a desired product, he or she brings the portable user terminal 20 close to the wireless apparatus corresponding to that product, and send a signal. When this is done, it is necessary that the signal to be received is received by only the targeted wireless apparatus 10 to 1n, and not be received by neighboring wireless apparatuses 10 to 1n. For this reason, it is necessary to adjust beforehand the sending and receiving levels of the transceivers 101 of the wireless apparatus 10 to 1n. In the Bluetooth standard, although transmitting and receiving are possible up to a distance of approximately 100 meters, when use is made for the above-noted purpose, if the product interval is 1 meter, for example, adjustment is made of the transceivers 101 of each of the wireless apparatuses 10 to 1n so that communication is possible when the portable user terminal 20 is brought to within a distance of 20 to 30 cm.

Returning to the operational description, when the wireless apparatus 10 receives a product information request signal at its transceiver 101 from the portable user terminal 20, the controller 102 obtains a wireless apparatus identification number priorly stored in the storage unit 103, and sends this wireless apparatus identification number and product information request signal to the store terminal 30. The wireless apparatus identification number is a characteristic number indicating the location of each wireless apparatus on the LAN, and there is no duplication of these numbers within the system. The store terminal 30 can discriminate the source of the transmission by means of this wireless apparatus identification number (step A2).

At the store terminal 30, when the wireless apparatus identification number and product information request signal are received from the wireless apparatus 10, the product information requesting means 31 searches the wireless apparatus identification number/product information database 34, based on the wireless apparatus identification number, and sends the corresponding product information to the portable user terminal 20 via the wireless apparatus 10 (steps A3 and A4).

At the portable user terminal 20, first the product information as shown in FIG. 3 is displayed on the display unit 25 of the portable user terminal 20 (step A5). In the case in which the customer first obtains the product information, and then goes home and then inquires about or purchases the product, the display product information is stored in the storage unit 24 of the portable user terminal 20 (step A6).

In the case in which there is another product that is to be purchased, the customer repeats steps A1 to A6 the required number of times, so that the product information for those products is added. After obtaining the product information for all products to be purchased, the * mark is input in the purchase field shown in FIG. 3, and the End of Product Selection button 200 on the screen is pressed. By doing this, all the total amount of the prices of all products for which the * mark is affixed in the Purchase field will be calculated (step A7).

When the End of Product Selection button 200 is pressed at step A7, the purchaser information screen shown in FIG. 4 is send from the order receiving means 33 of the store terminal 30 to the portable user terminal 20 and displayed thereat. The customer inputs the purchaser information from the screen. With regard to the specified delivery date, it is possible to input a delivery date and time that is after the quickest delivery date of the screen shown in FIG. 3 (step A8).

If the input of the purchaser information is completed at step A8, the customer presses the Order button 201 on the screen as shown in FIG. 4. By doing this, product information for all products tagged by * marks in the purchase field at step A3 and purchaser information input at step A8 are sent to the store terminal 30 (step A9).

At the store terminal 30, the order receiving means 33 receives the product information and the purchaser information, and generates characteristic order identification information therefrom, adding this order identification number thereto and then storing the information in the order information database 35 (step A10). In order to give notification of the reception of an order, the order receiving means 33 sends order identification number to the portable user terminal 20 (step A11), the order identification number received at the portable user terminal 20 being displayed by the display unit 25 thereof (step A12).

After step A6, in the case in which a product is being ordered from outside the store (for example, from the customer's home), the customer accesses the website of the store terminal via a public network 50 and orders desired products.

As described above, in the present invention because it is sufficient to merely display products within the store to show the products, it is possible to achieve efficient use of the sales area floor space. In the same manner, even in the case of a temporary event site, at which a new product sample is to be displayed, it is possible by applying the present invention to easily retrieve product information and purchase a product.

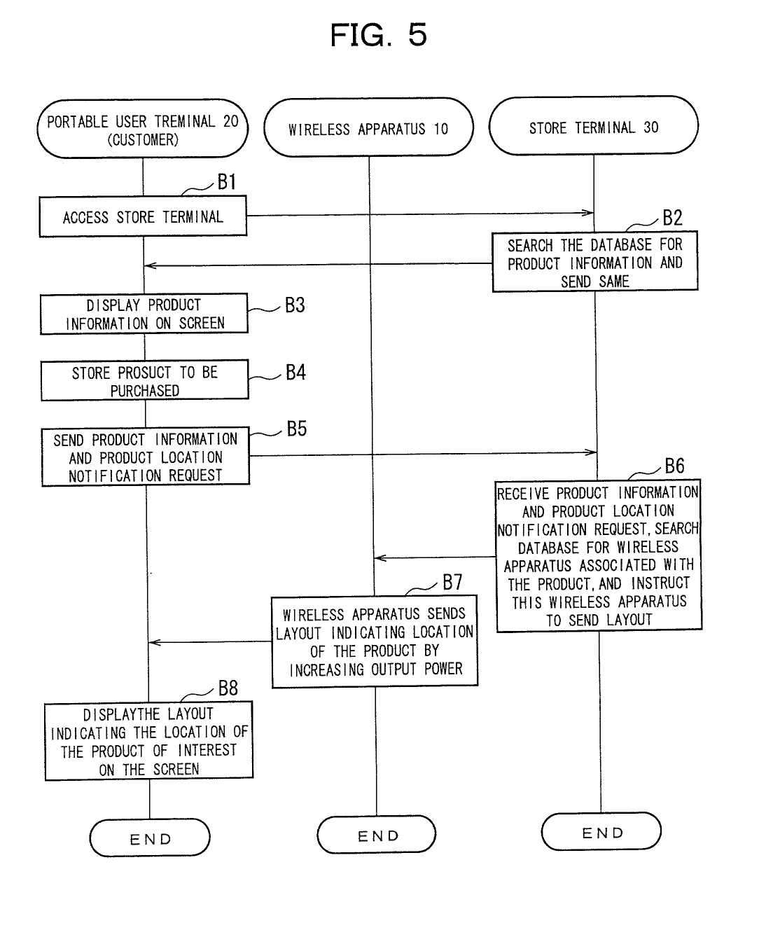

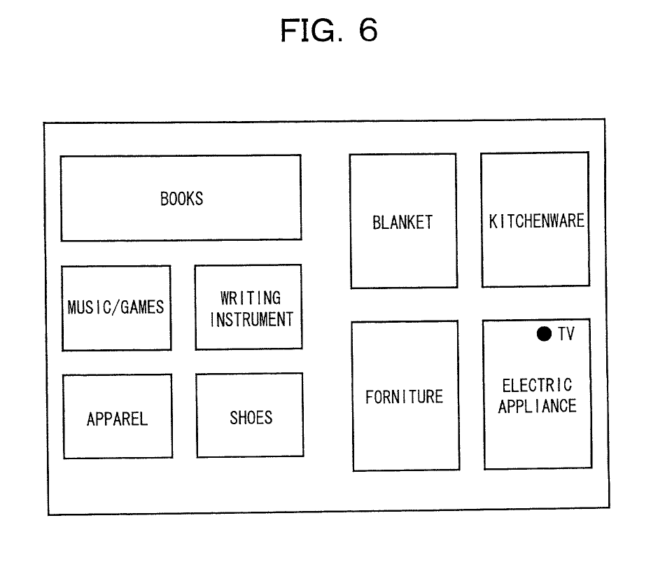

Next, the operation in the case of retrieval of the display location of a desired product is described below, with references made to FIG. 1, FIG. 5, and FIG. 6. FIG. 5 is a flowchart showing the operation of an embodiment of the present invention when a product display request is made, and FIG. 6 is a drawing showing an example of a store layout screen indicating the display location of a product in an embodiment of the present invention. This product location display request assumes that, after the customer obtains product information at the portable user terminal 20 via the network 50, the customer goes to the store and views the actual product displayed there.

Referring to FIG. 5, a customer outside the store (for example, at home) accesses the store terminal 30 via a public network 50 from a portable user terminal 20 (step B1). At the store terminal 30, a search is made for the requested product information, which is then sent to the portable user terminal 20 (step B2), whereupon the portable user terminal 20 displays the information on a screen shown in FIG. 3 (step B3). The customer views the product information displayed on the screen and, if the customer wishes to view the actual product, he or she registers and stores the corresponding product information into the storage unit 24 of the portable user terminal 20 (step B4).

Next, the customer goes to the store to which the portable user terminal 20 belongs and reads out the product information that has been registered and stored in the storage unit 24 of the portable user terminal 20, so as to cause it to be displayed on the display unit 25. The portable user terminal 20 is brought close to an arbitrary wireless apparatus of the wireless apparatuses 10 to 1n within the store and a product location request switch of the portable user terminal 20 is pressed so as to generate a product location request signal, thereby sending the product information and the product location request signal to the store terminal 30, via an arbitrary wireless apparatus (step B5).

At the store terminal 30, the product location request signal from the portable user terminal 20 is received, and the product location retrieval means 32 searches the wireless apparatus identification number/product information database 34, based on the received product information, and selects a wireless apparatus identification number corresponding to the product of interest, and sends a product location transmission request signal to the selected wireless apparatus (for example, the wireless apparatus 10) (step B6).

In the storage unit 103 of the wireless apparatus 10 that received the product location transmission request from the store terminal 30, the store layout such as shown in FIG. 6 is stored. In this store layout, the location marked by ● indicates the display location of the television desired by the customer, and also indicates location of the wireless apparatus 10 corresponding to the television. In the same manner, at other wireless apparatuses, the store layout with a ● mark at the respective display location is stored in each storage units 103 of other wireless apparatus.

The controller 102 of the wireless apparatus 10 increases the output level, so that the layout information obtained from the storage unit 103 is transmitted to the portable user terminal. In the case of the Bluetooth standard, because the communication range is up to approximately 100 meters at the maximum level, it is possible for a customer having a portable user terminal 20 to receive signals from the wireless apparatus 10, if the customer is within 100 meters from the wireless apparatus 10, thereby enabling reception throughout almost the entire store. Therefore, the output power of the transceiver 101 of the wireless apparatus 10 is beforehand set in accordance with the size of the store. In the transceiver 101 of the wireless apparatuses 10 to 1n, output power switching means are provided. In step A1 and A2 in FIG. 1, low power is outputted from the transceiver 101, and In step B7 in FIG. 5, high power is outputted from the transceiver 101. During transmission in high power, when the portable user terminal 20 approaches to the wireless apparatuses 10, the received level at the wireless apparatuses 10 to 1n exceeds a certain level, in this case output power switching means changes output power to the low power from the high power (step B7).

On the screen of the portable user terminal 20, the location at which the wireless apparatus 10 exists is displayed on the store layout, such as shown in FIG. 6. By doing this, it is possible for the customer to know the display location of the product of interest, thereby enabling the customer to directly examine it (step B8).

Using the present invention, when it is desired to learn the price or the like of a product displayed in a store, since it is only necessary to bring the portable user terminal close to a wireless apparatus provided corresponding to the product, so as to send a product information request signal, it is possible to obtain the desired product information without having to perform the troublesome task of directly inputting a product code associated with the product.

What is claimed is:

1. An in-store product information retrieval system having a portable user terminal, a wireless apparatus provided for each product displayed within a store and communicating with said portable user terminal, a store computer provided in said store and a network connecting said wireless apparatus with said store computer comprising:
a means for making a request for retrieval of product information from said portable user terminal when said portable user terminal approaches to within a prescribed distance of a wireless apparatus corresponding to a product for which retrieval of product information is desired;
a means for sending from said wireless apparatus to said store computer said request received from said portable user terminal by adding an identification number of said wireless apparatus;
a database provided in said store computer and storing product information;
a retrieval means, provided in said store computer, for performing retrieval of product information stored in said database based on said identification number of said wireless apparatus received from said wireless apparatus;
a sending means, provided in said store computer, for sending retrieval results to said wireless apparatus with said identification number; and
a receiving means, provided in said portable user terminal, for receiving retrieval results from said wireless apparatus.

2. The in-store product information retrieval system according to claim 1, wherein a plurality of said wireless apparatuses are provided in said store and said wireless apparatuses are disposed at regular intervals.

3. The in-store product information retrieval system according to claim 1, wherein said database comprising an identification number of said wireless apparatus and product information corresponding to said identification number of said wireless apparatus.

4. An in-store product information retrieval system comprising: a portable user terminal, a wireless apparatus provided for each product displayed within a store and communicating with said portable user terminal, a transmitter provided in said wireless apparatus, a memory, provided in said wireless apparatus, for storing store information of said store, a store computer provided in said store, and a network connecting said wireless apparatus with said store computer, said system further comprising:
a means for making a request for retrieval of store information from said portable user terminal to said wireless apparatus;
a transferring means, provided in said wireless apparatus, for transferring said request received from said portable user terminal to said store computer;
a retrieval means, provided in said store computer, for performing retrieval of a wireless apparatus that stores store information in a memory thereof, based on said request received from said portable user terminal;
an instruction means, provided in said store computer, for instructing a wireless apparatus obtained by said retrieval to transmit store information stored in said wireless apparatus to said portable user terminal;
a transmitting means for transmitting said store information stored in said wireless apparatus to said portable user terminal, based on said instruction of said store computer; and
a receiving means, provided in said portable user terminal, for receiving said store information from said wireless apparatus.

5. The in-store product information retrieval system according to claim 4, wherein said wireless apparatus communicates with said portable user terminal by a first output power of said transmitter, when receiving said request for retrieval from said portable user terminal, and said wireless apparatus communicates with said portable user terminal by a second output power that is different from said first output power, when transmitting said store information from said wireless apparatus to said portable user terminal.

6. The in-store product information retrieval system according to claim 4, wherein said wireless apparatus communicates with said portable user terminal by a prescribed output power of said transmitter, when receiving said request for retrieval from said portable user terminal, and said wireless apparatus communicates with said portable user terminal by a power that is equal to said output power, when transmitting said store information from said wireless apparatus to said portable user terminal.

7. A retrieval method in an in-store product information retrieval system having a portable user terminal, a wireless apparatus provided for each product displayed within a store and communicating with said portable user terminal, a store computer provided in said store, a database provided in said store computer and storing product information, and a network connecting said wireless apparatus with said store computer, said method comprising the steps of:
making a request for retrieval of product information from said portable user terminal when said portable user terminal approaches to within a prescribed distance of a wireless apparatus corresponding to a product for which retrieval of product information is desired;
sending from said wireless apparatus to said store computer said request received from said portable user terminal by adding an identification number of said wireless apparatus;
performing retrieval of product information stored in said database based on said identification number of said wireless apparatus received from said wireless apparatus;
sending retrieval results to said wireless apparatus with said identification number; and
receiving retrieval results from said wireless apparatus.

8. A retrieval method in an in-store product information retrieval system comprising a portable user terminal, a wireless apparatus provided for each product displayed within a store and communicating with said portable user terminal, a transmitter provided in said wireless apparatus, a memory, provided in said wireless apparatus, for storing store information of said store, a store computer provided in said store, and a network connecting said wireless apparatus with said store computer, said method comprising the steps of:
making a request for retrieval of store information from said portable user terminal to said wireless apparatus,
transferring said request received from said portable user terminal to said store computer;
performing retrieval of a wireless apparatus that stores store information in a memory thereof, based on said request received from said portable user terminal;
instructing a wireless apparatus obtained by said retrieval to transmit store information stored in said wireless apparatus to said portable user terminal;
transmitting said store information stored in said wireless apparatus to said portable user terminal, based on said instruction of said store computer; and
receiving said store information from said wireless apparatus.

9. The retrieval method according to claim 8, wherein said wireless apparatus communicates with said portable user terminal by a first output power of said transmitter, when receiving said request for retrieval from said portable user terminal, and said wireless apparatus communicates with said portable user terminal by a second output power that is different from said first output power, when transmitting said store information from said wireless apparatus to said portable user terminal.

10. The retrieval method according to claim 8, wherein said wireless apparatus communicates with said portable user terminal by a prescribed output power of said transmitter, when receiving said request for retrieval from said portable user terminal, and said wireless apparatus communicates with said portable user terminal by a power that is equal to said output power, when transmitting said store information from said wireless apparatus to said portable user terminal.
